(19) United States
(12) Patent Application Publication
(10) Pub. No.: US 2026/0145243 A1
(43) Pub. Date: May 28, 2026

(54) METHOD AND DEVICE FOR THE ADDITIVE MANUFACTURING OF ELECTROCHEMICAL DEVICES

(71) Applicant: EOS GMBH ELECTRO OPTICAL SYSTEMS, Krailling (DE)

(72) Inventor: Ulrich KLEINHANS, Krailling (DE)

(21) Appl. No.: 19/123,337

(22) PCT Filed: Oct. 24, 2023
(86) PCT No.: PCT/EP2023/079584

§ 371 Date: Apr. 22, 2025

(30) Foreign Application Priority Data
Oct. 24, 2022 (DE) 10 2022 128 036.5
Oct. 24, 2022 (DE) 10 2022 128 049.7

(51) Int. Cl. B22F 12/33; B22F 12/20; B29C 64/153; B29C 64/245; B29C 64/264; B29C 64/295; B29C 64/371; B29C 64/379; B33Y 10/00; B33Y 30/00; B33Y 70/00; B33Y 80/00

(52) U.S. Cl. CPC B22F 12/33; B22F 12/20; B29C 64/153; B29C 64/245; B29C 64/264; B29C 64/295; B29C 64/371; B29C 64/379; B33Y 10/00; B33Y 30/00; B33Y 70/00; B33Y 80/00

(57) ABSTRACT

Disclosed is a manufacturing method for the additive manufacturing of at least one component of an electrochemical device. The method can include providing a support device in the form of a support belt, applying at least one layer of the build-up material to the support belt, and supplying the build-up material to an irradiation area of at least one first, irradiation unit and at least partially solidifying, the build-up material on the support belt with the at least one first irradiation unit.

The invention relates to a manufacturing method as well as a manufacturing device for the additive manufacturing of at least one component of an electrochemical device, preferably of an electrochemical energy storage device, in particular of a rechargeable battery, preferably of a lithium-ion rechargeable battery, and/or of an electrolytic cell.

Manufacturing devices and corresponding methods for the (additive) manufacturing of components by layer-by-layer application and locally selective solidification of a build-up material are known in principle from the prior art. For the layer-by-layer application, at least one corresponding coating unit is usually provided. At least one corresponding irradiation unit (e.g. comprising at least one laser) is usually provided for the locally selective solidification. These features can also be realised in whole or in part in the invention.

In principle, it has already been proposed to employ such a method for additive manufacturing in the production of batteries. For example, US 2020/0411838 A1 describes a manufacturing method for a component of an electrical storage system, wherein a substrate is coated with a particulate build-up material, which is then solidified after the coating by a laser unit. In the usual way, further layers are then applied and solidified in each case. This approach, which is based on the usual procedure in the field of laser sintering processes and similar processes, is perceived as comparatively expensive and partially also as restrictive (in particular, as comparatively slow and costly) with regard to the production of large numbers, in particular for battery components.

The object of the invention is therefore to propose a manufacturing method, as well as a corresponding manufacturing device, whereby an electrochemical device to be manufactured, preferably an electrochemical energy storage device, in particular a rechargeable battery, preferably a lithium-ion rechargeable battery, and/or an electrolytic cell, can be manufactured in a comparatively simple yet precise manner (in particular also in large numbers and/or with a high throughput, for example measured as area produced per minute).

This object is achieved in particular by the features of claim 1.

In particular, the object is achieved according to a first aspect by a manufacturing method for the additive manufacturing of at least one component of an electrochemical device (device for an electrochemical application), in particular an electrochemical cell, preferably (at least one component) of an electrochemical energy storage device, in particular a rechargeable battery, preferably a lithium-ion rechargeable battery (for example a rechargeable battery cell structure and/or an electrode structure of a rechargeable battery or a rechargeable battery cell, in particular a lithium-ion rechargeable battery), and/or an electrolytic cell, at least partially by layer-by-layer application and subsequent, in particular selective, solidification of a, preferably pulverulent, build-up material, preferably by (in particular selective) irradiation, preferably by at least one laser, comprising the steps of:
providing a (preferably at least partially flexible) support device in the form of (or comprising) a (preferably at least partially flexible) support belt, in particular comprising or formed by a preferably metal (in particular comprising at least 30 wt. %, preferably at least 50 wt. %, more preferably at least 80 wt. %, of metal), support foil,
applying at least one (in particular dry) layer of the build-up material to the support belt,
(successive, preferably continuous) feeding of the build-up material to an irradiation area of at least one first, preferably stationary, irradiation unit and at least partial solidification, in particular selective solidification, of the build-up material on the support belt by means of the at least one first irradiation unit.

One idea of the first aspect lies therein that a (preferably flexible) support device, preferably in the form of a support belt-or comprising such a belt-is used for the (additive) manufacturing method, which is (successively) introduced into an irradiation area of the irradiation unit. This makes it possible to produce comparatively flat electrochemical components or component parts (in particular rechargeable battery components) in a simple manner. Furthermore, it is possible to move or irradiate comparatively quickly. In particular, one or several layers with a special structure (e.g. directed porosity and/or special chemical composition) can be produced. For example, after the solidification of the (respective) layer, a support material (e.g. formed by the support device or the support foil) can be moved on so that an area of the support material covered with solidified build-up material is guided out of the irradiation area, wherein, preferably, at the same time, a further section of the support material (on which no solidified build-up material is yet present) is moved into the irradiation area. In this way, a large area of the support material can (successively, preferably continuously) be provided with solidified build-up material (in particular, can be printed on).

Overall, large areas can be provided with a structure in a simple and fast manner (e.g. by separating or cutting individual sections of solidified build-up material and/or of supporting material bearing solidified build-up material) and large numbers can be achieved for a specific component to be manufactured.

In particular, the object is solved according to a second aspect (generally independent, but preferably to be combined with the first aspect) by a manufacturing method for the additive manufacturing of at least one component of an electrochemical device, preferably (at least one component) of an electrochemical energy storage device, in particular a rechargeable battery, preferably a lithium-ion rechargeable battery, and/or an electrolytic cell, at least partially by layer-by-layer application and subsequent, in particular selective, solidification of a preferably pulverulent build-up material, comprising the steps of:
applying at least one layer of the build-up material to a support device,
at least partial solidification, in particular selective solidification, of the build-up material on the support device by means of at least one first irradiation unit, wherein the first irradiation unit has a plurality of individual radiation exit sections, preferably arranged in at least one row and/or (particularly preferably: and) at least one column, in particular a plurality of laser diodes and/or radiation guide ends. Insofar as an arrangement in rows or columns is explained here and below, there are preferably at least 5 or at least 10 or at least 50 rows and/or at least 5 or at least 10 or at least 50 columns.

One idea of the second aspect lies therein that for the (additive) manufacturing method a solidification is carried out by means of a (first) irradiation unit which has a plurality of radiation exit sections (for example at least 5 or at least 10 or at least 50 radiation exit sections). A radiation exit section is preferably understood to mean a section of the respective (for example first) irradiation unit at which the beam (e.g. light beam, in particular of a laser) (finally) exits the irradiation unit, whereby finally exiting is preferably understood to mean that the beam (light beam) no longer comes into contact (or interaction) with a solid body until it impinges the build-up material to be solidified (wherein a transparent intermediate structure, which at least does not significantly affect the beam path, is preferably to be disregarded). Further above and in the following, the respective radiation may preferably be electromagnetic radiation, in particular visible and/or infrared light, preferably from a laser and/or a laser diode.

In principle, a plurality of radiation exit sections can be realised by a plurality of radiation sources (e.g. laser diodes) and/or a splitting of a beam of a (common) radiation source.

A radiation guide end is preferably understood to mean the end of a (physical) radiation guide, for example an optical fibre. A plurality of radiation exit sections can also be realised with the aid of at least one prism and/or at least one lens, in particular a micro lens, and/or at least one mirror, in particular a micro mirror.

Overall, the special configuration of the irradiation unit according to the second aspect allows large areas to be provided with a structure in a comparatively simple manner (in particular also if the build-up material is at least one metal) and large numbers for a specific component to be produced to be achieved (by separating or cutting individual sections of solidified build-up material and/or of supporting material carrying solidified build-up material) (similar to the first aspect). In particular, a combination of the first and second aspects can therefore enable improved production in this respect in a synergistic manner. In particular, with the plurality of radiation exit sections, as well as the use of a moving support belt, a comparatively large area can (simultaneously) be irradiated and (selectively) solidified, whereby the use of the support belt allows for easy replenishment of build-up material to be solidified.

The following explanations refer (unless the respective context indicates otherwise) to the first and second aspects (as respective optional further developments of the first or second aspect or as a further development of a combination of the two aspects).

A further (second) irradiation unit can be provided, but does not have to be.

The (respective) support device preferably comprises a support material that can be formed, for example, by the support belt, in particular the support foil. The support device can be supported, at least in sections, by a base. The base can comprise a belt (e.g. a conveyor belt) and/or a processing and/or support table and/or at least one roll and/or at least one supporting lamella, preferably a plurality-of, e.g., at least 5 or at least 10 or at least 20-supporting lamellae. In particular, a support device is to be understood as a device on which the build-up material is (directly) applied. The (respective) support device can be single-layer or multi-layer. The (respective) support device can be constructed in one piece, possibly monolithic, or in several pieces. Alternatively or in addition to a support belt, a (possibly non-flexible or conventional) building platform can also be used as support device. Such a building platform can, for example, be less than 10 times or less than 2 times as long as it is wide, wherein a length (here and below) is preferably understood in a plan view (vertical viewing angle from above, isometric) the longest extension along an axis of symmetry or (if no axis of symmetry is formed) the distance of that pair of points which has the greatest distance of all the pairs of points to one another, and wherein the width is understood to be the (maximum) extension perpendicular to the length.

The (respective) support device, preferably support foil, can be produced partially or completely additively, for example to achieve porous structures, in order to reduce weight if necessary.

In principle, it is possible to apply only one layer of the build-up material to the support device (in particular the support material) and then to solidify it (there). However, the steps of application of a layer of the build-up material and subsequent (at least partial) solidification of it, in particular selective solidification, can be repeated at least 1 time, optionally at least 2 times or at least 5 times (whereby the support device or the support material can be moved on for this purpose or can be located at the same place where a respective layer lying thereunder has been solidified, which will be explained in more detail below).

The process of solidification is preferably a (selective) laser sintering or laser melting process.

A flexible support material is preferably a dimensionally unstable material, for example such that the material can be wrapped around a straight circular cylinder with a diameter of 20 cm (at 20° ) without tearing, preferably without it moving away from the straight circular cylinder (after such an arrangement) due to elastic restoring forces. Alternatively or additionally, a flexible substrate may be a material of which a square cut-out of the same with an edge length of 10 cm sags by at least 1 mm or at least 1 cm under its own weight when the square cut-out is supported on two supporting lines that extend along two opposite edges of the square. Should a flexibility resulting from that not be uniform across the support material, this condition shall apply in particular to at least one square cut-out (edge length 10 cm), preferably to corresponding square cut-outs that cover at least 50% of the substrate area in total (optionally to the entire substrate or all corresponding cut-outs). The (flexible) support material may have a thickness of preferably less than 2.0 mm, more preferably less than 1.00 mm, even more preferably less than 0.50 mm, optionally less than 0.050 mm or less than 0.015 mm or less than 0.008 mm or even less than 0.004 mm. Alternatively or in addition (unless logically excluded by the preceding upper limit values), a thickness of at least 0.001 mm, preferably at least 0.005 mm, optionally at least 0.010 mm, may be present. Each of the upper and each of the lower limit values may be combined to a corresponding range (unless logically excluded).

The support material is in particular a (metallic) foil (support foil). The support material (in particular the support foil) preferably comprises aluminium (in particular at least 50 wt. % or at least 80 wt. %), preferably for producing a cathode, and/or copper (in particular at least 50 wt. % or at least 80 wt. %), preferably for producing an anode.

The additively manufactured component can, for example, be a (functional) layer of the electrochemical device and/or, for example, an anode and/or cathode and/or a separator of a rechargeable battery.

In embodiments, for example, at least 10 wt. %, preferably at least 30 wt. %, optionally at least 60 wt. % of the electrochemical device (e.g. the rechargeable battery) can be produced by the manufacturing method according to the invention.

The electrochemical device may be an electrochemical apparatus, an electrochemical part and/or an electrochemical component, in particular an electrochemical cell, preferably a battery cell, fuel cell and/or electrolytic cell.

The support material (or the support foil) can basically be (partially or completely) a part of the additively manufactured component (or remain in/on the component or a corresponding component), for example, be a part of an electrode (cathode or anode) of a rechargeable battery, or be removed (at least partially) at a later time (thus in particular only-or at least partially only-be used as a transport base or transport foil).

Preferably, a selective solidification takes place (so that not the entire respective layer is solidified). Alternatively, however, the entire layer of build-up material can be solidified by the irradiation unit during solidification. Any non-solidified portions of the build-up material can be removed from the solidified parts in a subsequent step (e.g. by suction, in particular by means of at least one suction nozzle).

In the region of (possibly selective) solidification, all of the material (in the respective layer) can be melted or only part of the material. If a material mixture is present, for example, only one component of the material mixture can be melted, for example a binder (in particular a polymer binder), for example to join (not per se, at least not completely) melted metal particles (in particular particles with at least 50 wt. % or at least 80 wt. % metal).

A binder, in particular the above-mentioned binder (in particular polymer binder), is preferably configured in such a way that it adheres to the support device, in particular the support foil, during melting and thus bonds with it.

In general, non-solidified build-up material can be recycled, preferably for the production of a new layer or a new cell, preferably a pouch cell and/or a cylindrical cell. A recycling of unused powder (build-up material) can, for example, comprise pneumatic conveying and optionally admixing of fresh powder.

The step of solidification can also include a step of bonding the build-up material to the support material, which is particularly advantageous if the support material is to be part of the component of the electrochemical device (or the corresponding electrochemical component). However, even if the support material is removed from the build-up material in a subsequent manufacturing step, an (at least comparatively loose) bonding can be advantageous, for example for further transport. If necessary, in such a case (or also in general), an intermediate layer can be provided between the support material and the build-up material, which makes it easier to subsequently detach the build-up material from the support material.

Preferably, there is relative movement between the support device and the coating unit (during coating) and/or between the support material and the irradiation unit (during irradiation). For this purpose, the support device can be moved while the coating unit or the irradiation unit remains stationary, or vice versa. Alternatively, both the coating unit or irradiation unit as well as the support device can also move. If, here and in the following, there is no explicit indication to the contrary, when there is mention of a movement (moving away), this should preferably (unless the context indicates otherwise) be understood as movement perpendicular to a build-up direction (z-direction).

In particular, a stationary irradiation unit is to be understood as an irradiation unit that is not (optionally not at all) moved during the solidification of the build-up material (in absolute terms, in particular in relation to a reference point that, during use, is part of the base on which the manufacturing device is located). The solidifying radiation (e.g. the respective laser beam) can move (also in absolute terms) or remain stationary (wherein, in both cases, a (possibly additional) relative movement with respect to the build-up material can be realised by moving away the latter).

Optionally, a (respective) radiation exit section (optionally several radiation exit sections) of the irradiation unit can always irradiate the same (sub-)area of an irradiation area. This does not necessarily have to apply to the irradiation unit as a whole if, for example, individual radiation exit sections are switched on and individual radiation exit sections (possibly several radiation exit sections) are switched off.

In any case, the irradiation itself can (optionally) move locally, for example by moving a laser beam, in particular by deflecting it (for example in a raster). A laser beam can, for example, be moved by MEMs (MEM=micro-electromechanical-mirror).

The manufacturing method is preferably an endless process, in particular a conveyor process. For this purpose, a corresponding endless support can be provided. Alternatively or additionally (in the sense of a hybrid process), the manufacturing method can also be discontinuous, so that, for example, build-up material is built up on a (single) support device (or is solidified there), then (together with the support device or at least parts thereof) is removed from the area of solidification and then a further (new) support device is brought into an irradiation area and is provided there again with build-up material (which is solidified there).

The support material (or the support belt or the support foil) is, according to the embodiment, in an initial state, preferably at least 2 times, preferably at least 5 times, even more preferably at least 10 times and/or at most 100,000 times as long as it is wide.

Preferably, the support material is provided in belt-like form (in the form of a belt, preferably a foil belt).

According to the embodiment, the support material (or the support belt and/or its support foil) is preferably provided in an at least partially rolled-up state (optionally completely rolled up in the initial state). Alternatively or additionally, the support material (or the support belt and/or its support foil) can be provided in a folded state (for example folded at least twice or at least five times or at least ten times), or also partly in a rolled-up state and partly in a folded state. This allows the support material to be provided in a space-saving manner.

The support material (or the support belt and/or its support foil) can be rolled up and/or folded at least in part (after the build-up material has solidified), optionally together with the build-up material (or at least parts of the build-up material) or without the build-up material.

A jointly rolling up or folding together with the build-up material is particularly advantageous if the support material is to be part of the electrochemical device. However, even if the support material (or the support belt and/or its support foil) is not part of the build-up material, initially a jointly rolling up or folding can take place (for example for transport and/or storage purposes).

In embodiments, the build-up material can be transferred after solidification from a support material of the support belt, preferably formed by the support foil, hereinafter also referred to as first support material-to a further, possibly flexible, second support material, preferably in a roll-to-roll process, or can remain on the first support material. Alternatively, the build-up material can also remain on/at the (first) support material (and become part of the electrochemical device to be manufactured). The second support material can optionally be designed as described (above and/or below) in connection with the first support material.

Alternatively or additionally, a layered structure (sandwich), comprising in particular a support material (support foil) of the support belt or the support belt itself and the (solidified) build-up material, can be divided into at least two (smaller) strips or divided into individual (e.g. rectangular) plates (in particular for pouch cells).

Preferably, a back side of the support belt and/or of its support foil is also provided with a (in particular selectively) solidified layer of a build-up material. In order to be able to irradiate the back side by means of the irradiation unit, a deflection roll, for example, can be provided. In this way, for example, a rechargeable battery can be manufactured in a particularly effective manner.

In embodiments, the application can be carried out by means of a stationary coating unit. Alternatively or additionally, the solidification can be carried out by means of a stationary irradiation unit (in particular as defined above).

A stationary coating unit is in particular to be understood as a unit that does not move (itself) during the coating process, so that, for example, a coating is applied by moving the support material (or support belt or at least its support foil) under the coating unit. Alternatively, the coating unit can also be moved (at least partially), in particular a coating arm of the same.

The irradiation unit can have a plurality of individual radiation exit sections (preferably arranged in at least one row and/or in at least one column), in particular a plurality of laser diodes and/or radiation guide ends.

Specifically, the irradiation unit can have a matrix of radiation exit sections. If a plurality of radiation exit sections is provided, a matrix of impingement points is made possible, wherein each impingement point is associated in particular with a corresponding radiation exit section (wherein the impingement point is an area of the build-up material or build-up area that is irradiated by the respective radiation exit section).

If several impingement points are arranged one behind the other in a longitudinal direction (or direction of movement of the build-up material), these can be aligned (in the longitudinal direction; with at least one nearest neighbour). However, in such a case, there may advantageously also be an offset to at least one nearest neighbour in the width direction (in particular such that at least two successive impingement points in the longitudinal direction are not aligned with one another in the longitudinal direction). The same may also apply to the radiation exit sections, although there does not need to be a compelling connection here (for example, if angles of beams associated with corresponding radiation exit sections deviate from each other, so that there is no offset in the width direction with respect to the radiation exit sections, but with respect to the impingement points there is). Overall, for at least 30% or at least 50% of all impingement points and/or radiation exit sections it may apply that these are offset with respect to at least one of their, in relation to the longitudinal direction, nearest neighbours (longitudinally preceding and/or following).

With such an offset, gradations (steppings), which can arise in particular if a plurality of radiation exit sections irradiate the same row (in the longitudinal direction) can be reduced or avoided in a simple and thus advantageous manner.

The respective radiation exit section can preferably be configured for constant (stationary) irradiation.

Preferably, the support material (or the support belt) moves on through the irradiation unit during irradiation. In this case, the movement of the support belt or support material is doubly used in a synergistic manner, namely, on the one hand, to advance the support material and, on the other hand, to (selectively) be able to introduce structures into the build-up material. Alternatively, the support material can also be immobile (with respect to the irradiation unit or exposure unit) during irradiation. Corresponding (selective) structures can be achieved, for example, by switching individual radiation exit sections (e.g. laser diodes) on or off and/or (in the conventional manner) by scanning with one or several laser beams (as in the case of a moving support material).

The irradiation unit preferably comprises at least one laser. Further preferably, the irradiation unit comprises at least one VCSEL (=Vertical-Cavity Surface-Emitting Laser) and/or VECSEL (Vertical-External-Cavity Surface-Emitting-Laser). Further preferably, the irradiation unit comprises a VCSEL-and/or-VECSEL arrangement, preferably comprising a plurality of VCSEL-and/or-VECSEL diodes, in particular in a matrix arrangement having a plurality of rows and columns. A wavelength of the respective laser diode is 405-1400 nm, preferably 900-1000 nm, particularly preferably 940-980 nm. Further preferably, the wavelength can be matched to an absorption band of a build-up material.

Alternatively or additionally, the irradiation unit can also comprise one or several lasers, which can be moved over the building field or the irradiation area (in a raster) by means of a number of (polygon) scanners.

Preferably, in addition to a first irradiation unit with a plurality of individual radiation exit sections (preferably arranged in at least one row and/or at least one column), an auxiliary irradiation unit (preferably at least one, in particular scanning, auxiliary laser unit), such as for example a CO, CO₂, fibre and/or Nd: YAG laser, is used. In particular, scanning can be carried out by means of a galvanometer scanner and/or polygon scanner and/or a micro-mirror array. Alternatively or additionally, a beam can be moved over the building field or the irradiation area by means of a single-or multi-axis linear drive. In general, a micro-electro-mechanical system (MEM) can be used.

For certain applications (component structures), it may be advantageous not only to irradiate/solidify in a raster-like manner (with constant or variable raster size), as is made possible, for example, with a matrix exposure unit or a polygon scanner, but also to form curved solidification paths, e.g. by means of a galvanometer mirror. Alternatively or additionally, a light guide (optionally a light guide line or a light guide array) can be provided, which can optionally be moved relative to the building field in the x/y direction, e.g. by means of a two-axis linear drive (which can be achieved, for example, by movement alone or by interaction with a movement of the support device).

Furthermore, structuring (e.g. the introduction of local holes) may be of interest. Specifically, the laser beam can be moved from position to position and remain at a location for a short, defined period of time.

The above auxiliary irradiation unit (or complementary irradiation unit, in particular complementary laser) can be, for example, a CO₂ or Nd: YAG laser (e.g. with scanner-based control), in particular for melting of metals and/or polymers that cannot be melted with the wavelength and/or power of a VCSEL and/or VECSEL or another diode laser, for example due to a lack of absorption of the energy applied. In particular, the emission wavelengths of a CO laser (in the mid-infrared region 4.8-8.3 μm) and/or a CO₂ laser (in the mid-infrared region, in particular 9.4 and 10.6 μm) are suitable for processing (solidifying) metal-containing, in particular lithium-containing, ceramics and oxides. Even if, for example, conductive soot is added as an absorber, it may not be possible to melt all conceivable build-up materials satisfactorily (without such a measure).

Preferably (in particular with regard to the second aspect, possibly also with regard to the first aspect), the application is carried out by means of a movable coating unit. Alternatively or additionally (in particular with regard to the second aspect, and possibly also with regard to the first aspect), the solidification is carried out by means of a movable irradiation unit. A movable coating unit is preferably understood to mean that the coating unit (as a whole), i.e. for example not just a coating arm, can be moved in such a way that it can be arranged over different areas (e.g. different individual building fields), for example in order to apply several components (of the same or different shapes) in one plane. The method preferably takes place in a translational manner in one direction, particularly preferably in an alternating manner between two end positions that abut against or are close to the ends of the building field.

If necessary, the coating unit is movable in such a way that different layers (for example, layers arranged at the same height) can be applied. In particular, the movability is not limited (solely) to the fact that moving is used for the purpose of applying layers. In general, however, the coating unit can be one that is moved (possibly exclusively) for the purpose of layer application. The (movable) irradiation unit is preferably configured such that it can be moved (as a whole), for example, to (selectively) solidify the aforementioned layers that are located beside each other and that have been applied by the coating unit. By means of such a movable coating unit and/or such a movable irradiation unit, comparatively large areas of a support material can be provided with a (selectively) solidified build-up material. A separation can then be carried out, for example, by separating the support material (including build-up material) or separating the build-up material.

A building field for solidification is preferably rectangular, circular, circular-segmental, circular-sector-shaped, ring-shaped or ring-segmental shaped.

In embodiments, a rotational (continuous) coating is carried out. For example, a rotating coating device can be designed for this purpose. This can result in a helical solidification.

A coating unit for applying the build-up material preferably comprises at least one roll (possibly exactly two or exactly three or more rolls), wherein preferably at least one of the possibly several rolls is assigned a drive unit. Further preferably, a circumferential speed of the (respective) roll can be adjustable in relation to a (relative) moving speed of the substrate material with respect to the respective roll. For example, the circumferential speed of the roll may be the same as the moving speed of the substrate material relative to the respective roll. Alternatively, the circumferential speed of the roll may be different from (lower or higher than) the moving speed of the substrate material relative to the respective roll. The movement of the circumference of the (respective) roll in a section facing the substrate material is preferably adjustable. For example, it can run in the same or in the opposite direction relative to the movement of the substrate material.

The (respective) roll of the coating unit can have a diameter of 10 mm-200 mm. The direction of rotation and speed can be mentioned as well.

Two rolls can be arranged at different z-height levels. An applicator roll can form a flat layer of a first height from a metered powder. A downstream compacting roll can compact the levelled layer because it is at a lower level. In alternating operation (alternating application), the rolls can change their height position layer by layer.

The (respective) roll can be designed as a compactor (in particular for compacting an applied layer).

The (respective) roll (compactor) can have an adhesion reducing agent to reduce the adhesion of build-up material to the roll surface.

At least one roll can extend at least essentially across the entire width of the support material, in particular across at least 70% or at least 90% or at least 99% of the width.

The (respective) roll can vibrate (during coating) or at least be able to be made to vibrate.

A wiper can be assigned to the (respective) roll in order to wipe off build-up material adhering to the roll.

Furthermore, the (respective) roll can have a fluidising device, which for example comprises channels for supplying a (possibly pressurised) gas. This can, for example, break up powder bridges and/or enable the build-up material (powder) to flow after.

A distance between at least one roll and a support material (or the support foil) can be adjustable, for example in a range of 5-500 μm, preferably 10-100 μm, particularly preferably 50-70 μm. Thereby a layer thickness can be adjusted in a simple manner.

The coating unit can be designed as a multi-chamber coater (e.g. for locally targeted dosing and for applying at least two build-up materials). The coating unit can have at least one dosing unit, which preferably comprises at least one chamber dosing device and/or one or several controllable outlets. The dosing unit can extend at least essentially (i.e. in particular to at least 70% or to at least 90% or to at least 99% of the width) across the entire width of the substrate. The dosing unit can vibrate (at least in sections) during the coating or at least be able to be made to vibrate. Alternatively or additionally, the dosing unit can have a fluidisation device which, for example, comprises a plurality of channels through which (in particular pressurised) gas can be supplied.

If the dosing unit comprises several controllable outlets, these can preferably (selectively) be opened or (selectively partially or completely) be closed, so that a dosing is or can be varied across the width of the support material.

The solidification can take place in a process chamber. A process gas atmosphere (in particular a process gas atmosphere in the process chamber) can be essentially free of oxygen (e.g. have an oxygen content of less than 10,000 ppm, preferably less than 1000 ppm, more preferably less than 500 ppm, particularly preferably less than 200 ppm). Alternatively or additionally, the process gas atmosphere can comprise at least 50 vol. %, preferably at least 90 vol. %, more preferably at least 99 vol. %, of at least one inert gas, such as nitrogen, and/or at least one noble gas, such as Ar or He.

A process gas flow (in particular a protective gas flow) over the respective applied layer of build-up material applied can preferably be at least essentially perpendicular to a conveying direction of the build-up material and/or a coating direction of the build-up material.

A monitoring unit can be formed which can detect, for example, defects and/or abnormalities or deviations, for example a delamination.

Such a monitoring unit can preferably be based on optical tomography, i.e. a spatially resolved measurement of heat radiation which emitted originating from the building field. The monitoring unit can, for example, be designed equally for the selective solidification of (in weight per cent predominantly) metallic and (in weight per cent predominantly) polymeric build-up material, for which, for example, a correspondingly high sensitivity, in particular also in a lower temperature range, can be ensured. It would also be conceivable to work with two separate monitoring units or to form a monitoring unit with shared optics that can be connected via two signal-processing strands (which, for example, are optimised in one case for a comparatively high temperature range and in another case for a comparatively low temperature range and/or have different bandpass filters).

Alternatively or additionally, active tomography can be used, in particular to check for adhesion to a support foil. In this case, energy (e.g. flash light) can be applied to the support foil and the layer can be recorded with a thermal camera. Wherever the layer has not bonded properly, it will become warmer because it cannot transfer the energy to the substrate/foil.

The support material or support belt can run completely or partially within the process chamber or process gas atmosphere. For example, the support material or support belt can be introduced into the process chamber on one side and led out again on the other side.

The irradiation unit can comprise at least one radiation source, in particular at least one laser device, which is designed to emit focused radiation that impinges on the build-up material in a localised manner. In particular, this is to be understood as an irradiation in which no mask is used to allow a broadly dispersed irradiation to only selectively impinge on the build-up material.

At least one solidification zone, in which the build-up material is solidified, can preferably be heated or cooled (indirectly or directly), more preferably by heating or cooling the support device and/or by heating or cooling a base (e.g. a support table) for the support device and/or by heating or cooling the build-up material, for example by means of radiation, optionally by means of the irradiation unit for solidification and/or a further irradiation unit, e.g. an infrared radiation source or a number of VCSEL emitters. Alternatively or in addition, heating can also be carried out by means of at least one resistance heating device, for example for heating the base.

By a heating (warming) and/or cooling corresponding differences, for example in terms of a melting temperature, in particular when using different materials (e.g. in different layers) can be compensated in a simple way, especially if the same irradiation unit is used. For example, during melting of a first layer, an additional irradiation with heat for heating (tempering) can be carried out and during melting of a second layer such an irradiation can be omitted or carried out only to a reduced extent and/or cooling can be carried out. The first layer may comprise (at least 30 wt. % or at least 50 wt. % or at least 70 wt. % or at least 90 wt. %) metal and the second layer may comprise (at least 30 wt. % or at least 50 wt. % or at least 70 wt. % or at least 90 wt. %) polymer; or vice versa. Heating (warming) or cooling is preferably understood to be an active heating or cooling. An (active) heating can be done, for example, by means of at least one resistance heater and/or a radiant heater. Alternatively or additionally, an (active) heating and/or cooling can be done, for example, by means of at least one heat pump and/or by means of at least one Peltier element.

For example, the respective build-up material can be heated to a temperature just below the melting temperature (e.g. to a temperature that is at most 10% below the melting temperature if it is expressed in ° C.). Here (above and below), a melting temperature is understood to be, in particular, a temperature at which the respective build-up material has a viscosity which is below 25,000 mPas, or below 5,000 mPas (preferably measured according to EN ISO 3219, as applicable at the priority date or filing date).

In particular in the case of an irradiation unit having a plurality of (in particular individually controllable) radiation exit sections (e.g. individual laser diodes), the power of individual ones of the radiation exit sections (laser diodes) can be controlled such that only a heating of the build-up material is done, while others are in turn controlled in particular such that (at least in conjunction with further radiation exit sections or laser diodes) melting occurs.

The build-up material can be selectively removed, in particular by suction, after an (initial) application and (possibly selective) solidification of the build-up material and optionally before a (possibly selective) application of a further build-up material, further preferably by means of at least one suction unit, preferably a suction nozzle arrangement, wherein the suction nozzle arrangement preferably comprises a plurality of suction nozzles, preferably arranged in rows and/or columns, and/or wherein the suction unit is preferably arranged on the coating unit.

Specifically, a suction nozzle row and/or matrix can be provided for targeted (local) suction of unsolidified build-up material. Particularly preferably a further (in particular other) build-up material be applied in those regions in which build-up material has been (locally) suctioned, so that, if necessary, different build-up materials can be (selectively) solidified in the same plane (or layer).

A suction-resolution of the suction device in the longitudinal and/or width and/or vertical direction is preferably at most 100 times, more preferably at most 20 times, more preferably at most 5 times, more preferably at most 2 times, even more preferably at most 1 time as large as a resolution of the irradiation unit.

The build-up material can be applied or layered (coated) in a dry state. The build-up material can comprise particles or be formed from a, in particular at least essentially dry, powder. The particles of the build-up material may have a (mean) particle size of at least 1 nm, preferably at least 100 nm, more preferably at least 1 μm and/or at most 200 μm, preferably at most 10 μm, more preferably at most 5 μm.

The grain size or particle size can possibly be determined using laser diffraction methods (in particular by means of laser diffraction measurement according to ISO 13320 or ASTM B 822). Alternatively or additionally, the particle sizes can be determined by measuring (e.g. using a microscope) and/or with dynamic image analysis (preferably according to ISO 13322-2, if necessary using the CAMSIZER® XT from Retsch Technology GmbH). If the particle size is determined from a 2-dimensional image (e.g. a microscope, in particular an electron microscope, possibly a scanning electron microscope), the respective diameter (maximum diameter or equivalent diameter) resulting from the 2-dimensional image is preferably used.

The (mean) grain size or particle size of the individual particles of the build-up material is preferably a d50 particle size. For the mean particle size, the d (numerical value) indicates the number of particles (in mass and/or volume per cent) that are smaller than or equal to the stated grain size or particle size (i.e. for a d50 of 50 μm, 50% of the particles have a size of ≤50 μm). The particle size is preferably determined by means of the diameter of a single particle, which in turn may be the respective maximum diameter (=supremum of all distances between any two points of the particle) or a sieve diameter or an (in particular volume-related) equivalent spherical diameter. If the particles are at least partially agglomerated, the respective particle size (grain size) should in particular be the size of the individual particle in the respective agglomerate (primary particle size).

The individual particles of the build-up material can be (at least approximately) the same size or there can be a particle size distribution.

Specifically, the build-up material may comprise a powder and/or a particle suspension (nanoparticle suspension).

Alternatively or additionally, the build-up material may be present (at least partially) liquid, e.g. of a synthetic resin in its initial state, or be pasty.

Alternatively or additionally, the build-up material can comprise at least one coherent body (if necessary, pre-solidified, e.g. by pressure during coating).

The build-up material can be provided and used in different variants (cumulatively or individually).

The build-up material can be a metal-containing build-up material and can comprise at least one pure metal and/or at least one compound containing at least one metallic element. Preferably, a metal-containing build-up material comprises lithium, for example in the form of pure lithium, and/or LFP (lithium iron phosphate), LCO (lithium cobalt oxide), and/or NMC (lithium nickel manganese cobalt oxide) and/or NCA (lithium nickel cobalt aluminium oxide) and/or LAGP (lithium aluminium germanium phosphate) and/or LATP (lithium aluminium titanium phosphate) and/or LLTO (lithium lanthanum titanate oxide) and/or LLZO (lithium-lanthanum-zirconium-oxide), all these materials optionally in the form of a metal-containing solid electrolyte ceramic. A metal-containing build-up material may also comprise aluminium, e.g. in the form of pure aluminium, and/or cobalt, e.g. in the form of pure cobalt, and/or nickel, e.g. in the form of pure nickel, and/or copper, e.g. in the form of pure copper. Such a metal-containing build-up material can comprise at least one metal and/or a compound containing at least one metallic element to at least 30 wt. %, or 50 wt. %, or 70 wt. %, or 90 wt. %, or to at least approximately 100 wt. %.

The build-up material can be a polymer-containing build-up material and can comprise at least one polymer, preferably PVDF (polyvinylidene difluoride) and/or PVDF-HFP (polyvinylidene difluoride-co-hexafluoropropylene) and/or PEO (polyethene oxide) and/or Nafion, optionally in the form of solid electrolyte polymers. In particular, at least one polymer in the polymer-containing build-up material can be a binder, for example PVDF. Such a polymer-containing build-up material can comprise at least one polymer to at least 50 wt. % or to at least 70 wt. % or to at least 90 wt. % or to at least approximately 100 wt. %.

The build-up material can be a metal- and polymer-poor build-up material and can comprise non-metallic elements and/or semiconductor (elements) and/or ceramic and/or oxides (apart from oxides that contain metallic elements). Preferably, a metal- and polymer-poor build-up material can comprise carbon, for example in the form of conductive soot and/or graphite, and/or silicon, for example in the form of pure (elemental) silicon and/or in the form of silicon oxide. Such a metal- and polymer-poor build-up material can be at least essentially non-metallic and can at least essentially comprise no polymer (preferably consist of at least 50 wt. % or at least 70 wt. % or at least 90 wt. % or at least approximately 100 wt. % of non-metallic and non-polymeric substances, e.g. ceramics and/or oxides and/or carbon and/or silicon). Particularly preferably, the metal- and polymer-poor build-up material comprises carbon (at least 50 wt. % or at least 70 wt. % or at least 90 wt. % or at least approximately 100 wt. %). In the context of the metal- and polymer-poor build-up material, ‘carbon’ is intended to mean that kind of carbon that is present in pure form (e.g. as graphite and/or as conductive soot, i.e. is not molecularly bound, for example in a polymer).

Furthermore, the build-up material can comprise a metal-containing and/or a polymer-containing and/or a metal- and polymer-poor build-up material. If a build-up material comprises build-up materials with different compositions each, these build-up materials with different compositions each are also referred to below as build-up material components. This means that a build-up material can comprise a metal-containing and/or a polymer-containing and/or a metal- and polymer-poor component, wherein a metal-containing, a polymer-containing and a metal- and polymer-containing build-up material component is, accordingly, formed from a metal-containing, a polymer-containing and a metal- and polymer-poor build-up material. In the following, in particular with regard to the component of an electrochemical device, active materials are also described. An active material is a component of an electrochemical device that results from the processing (e.g. from the solidification by irradiation) of a build-up material and/or a build-up material component. For example, a metal-containing active material results from the processing of a metal-containing build-up material or a metal-containing build-up material component (the same applies to the other build-up materials or build-up material components mentioned above and the corresponding active materials).

The build-up material may comprise additives (e.g. an antitacking agent and/or an absorber), which may be present in the form of separate particles and/or fibres or as part of composite particles. In particular, the build-up material may comprise a binder, which is optionally part of a polymer-containing build-up material.

The build-up material may comprise particles which at least partially have a metal and a polymer portion and/or a ceramic and a polymer portion or a metal and a ceramic portion (e.g. metal particles coated with a polymer binder). For example, metal particles and polymer particles (granules) and metal- and polymer-free particles can be mixed together, preferably in the above-mentioned weight ratios. Instead of or in combination with particles, fibres, e.g. carbon and/or ceramic and/or oxide fibres, can be used.

A metal-containing build-up material (or a metal-containing build-up material component) can comprise particles at least partly consisting of pure metal (e.g. lithium, copper, aluminium, cobalt, nickel) and/or particles at least partly consisting of a compound containing a metallic element (e.g. LFP, NMC, NCA, LCO, LAGP, LATP, LLTO, LLZO) and particles consisting of non-metallic and/or polymeric materials, which particles can be mixed with each other according to the above-stated weight ratios. Alternatively or in addition, a metal-containing build-up material can comprise particles at least partly consisting of pure metal (e.g. lithium, copper, aluminium, cobalt) and/or particles at least partly consisting of a compound (e.g. LFP NMC, NCA, LCO, LAGP, LATP, LLTO, LLZO) containing at least one metallic element, which particles may additionally comprise non-metallic and/or polymeric materials. For example, a metal-containing particle core can be coated with a non-metallic and/or with a polymeric material. Conversely, a non-metallic and/or polymeric particle core can be coated with a metal-containing material. The metal-containing portion (metal-containing particle core or metal-containing coating) and the non-metallic and/or polymeric portion (non-metallic and/or polymeric particle core or non-metallic and/or polymeric coating) are preferably in the above-mentioned weight ratios to each other.

A polymer-containing build-up material (or a polymer-containing build-up material component) may comprise particles at least partly consisting of a polymer material (e.g. PVDF, PEO, Nafion) and particles consisting of non-metallic and/or metal-containing materials, which particles may be mixed with each other in the above-mentioned weight ratios. Alternatively or in addition, a polymer-containing build-up material can comprise particles at least partly consisting of a polymer (e.g. PVDF, PEO, Nafion), which particles can additionally comprise non-metallic and/or metal-containing materials. For example, a polymeric particle core can be coated with a non-metallic and/or with a metal-containing material. Conversely, a non-metallic and/or metal-containing particle core can be coated with a polymeric material. The polymer-containing portion (polymeric particle core or polymeric coating) and the non-metallic and/or metal-containing portion (non-metallic and/or metal-containing particle core or non-metallic and/or metal-containing coating) are in the above-mentioned percentage weight ratios to each other.

A metal- and polymer-poor build-up material (or a metal- and polymer-poor build-up material component) can comprise particles at least partly consisting of metal- and polymer-poor material (e.g. ceramics, oxides, apart from metallic elements containing oxides, carbon, in particular conductive soot and/or graphite, silicon) and particles consisting of polymeric and/or metal-containing materials, which particles can be mixed with each other according to the above-mentioned weight ratios. Alternatively or in addition, a metal- and polymer-poor build-up material can comprise particles least partly consisting of a metal- and polymer-poor material (e.g. ceramic, oxides, apart from oxides containing metallic elements, carbon, in particular conductive soot and/or graphite, silicon), which particles can additionally comprise polymeric and/or metal-containing materials. For example, a metal- and polymer-free particle core can be coated with a polymeric and/or with a metal-containing material. Conversely, a polymeric and/or metal-containing particle core can be coated with a metal- and polymer-poor material. The metal- and polymer-free portion (metal- and polymer-free particle core or metal- and polymer-free coating) and the polymeric and/or metal-containing portion (polymeric and/or metal-containing particle core or polymeric and/or metal-containing coating) are in the above-mentioned percentage weight ratios to each other.

Alternatively or in addition, the build-up material can comprise at least one active material specific to the component/part of the electrochemical device, in particular:
a cathode active material (e.g. LFP, NMC, NCA and/or LCO), optionally a binder (e.g. PVDF, in particular 2-15 wt. %, preferably 3-5 wt. %) and conductive soot (in particular 0.1-10 wt. %, preferably 0.1-5 wt. %) and/or
an anode active material (typically graphite, optionally with proportions of, for example, 1-60 wt. %, optionally 10-15 wt. % silicon, and/or, optionally at least essentially pure, silicon), binder (e.g. PVDF, in particular 5 -15 wt. %) and conductive soot (in particular 0.1-10 wt. %, preferably 0.1-5 wt. %) and/or
a solid cell anode active material (e.g. lithium, in particular lithium powder, preferably without binder) and/or
a solid electrolyte material (e.g. a polymer-containing solid electrolyte comprising PVDF-HFP, PEO and/or Nafion, and/or a solid electrolyte comprising LAGP, LATP, LLTO and/or LLZO).

Alternatively or additionally, the build-up material can comprise: a separator, in particular for a (classic) battery. This can be formed as a (thin) polymer film. The polymer may comprise (if necessary at least 50 wt. % or 80 wt. %) polyolefin, e.g. polyethylene and/or polypropylene, and/or polyamide, e.g. PA 6 and/or PA 12 and/or PA 6.6, and/or polyester.

When using solid electrolyte polymers, comparatively good ion conductivity, good processability, as well as high flexibility can be expected if, for example, lithium metal anodes expand. If, for example, the anode expands, it is preferable if the separator (e.g. made of one or several solid electrolyte polymers) can absorb forces and yield flexibly.

A solid electrolyte ceramic or a corresponding oxide has the advantage of high stability over time and comparatively good performance. On the other hand, a comparatively high energy input is necessary to enable (at least partial) melting during (selective) solidification. With the measures proposed above and below (e.g. heating of a powder bed and/or an auxiliary irradiation unit, e.g. an auxiliary laser and/or a binder) such a generally present disadvantage can be counteracted.

In general, it is preferable to use a binder that has a comparatively high lithium-ion conductivity.

The support material (in particular for producing a cathode structure) can be an aluminium foil (for example with a thickness of 5-50 μm, in particular 10-15 μm, optionally also below 8 μm or even below 5 μm). Alternatively, the substrate material can be a copper foil with a thickness of 5-20 μm, in particular 10-15 μm, for example approximately at least 10 μm, possibly also less than 8 μm or even less than 5 μm.

To the (at least partially) solidified (first) layer, at least one further layer of a build-up material can be applied, which is also (completely or selectively) solidified. This can be repeated at least once (or as often as desired).

The build-up material of a respective (further) layer can differ from the build-up material of the first layer (or of a layer applied before or after), in particular with regard to a chemical composition and/or a structure, or can be formed identically to this build-up material. The further layer can be applied by means of a further and/or the same coating unit (with which the first layer has also been applied). The further layer can be solidified by means of a further or the same irradiation unit (with which the first or another layer has also been solidified). By this the respective layer can be influenced, for example, in its properties and/or structure. For example, a directional porosity and/or a porosity that changes across the layer can be created.

By a repetition of coating and irradiation (exposure), for example stronger or thicker layers of the same material and/or different layers can be applied in an easy manner. Alternatively, stronger or thicker layers can be created by applying a thicker or higher layer of build-up material and solidifying this layer with appropriately adjusted energy input parameter values of the irradiation unit.

In the (additive) manufacturing method, non-solidified build-up material can be recycled into the manufacturing method and used in a further solidification process. Before the build-up material is used in a further solidification process, it can be treated if necessary and/or mixed with fresh powder.

The solidification of a build-up material, in particular of a polymer-containing build-up material and/or of a build-up material comprising a polymer-containing build-up material component, is preferably carried out by (selectively) melting at least one polymeric material. The solidification of a build-up material is particularly preferably carried out by (selectively) melting a binder. Due to the melting and the successive solidification of a binder or a polymer material, other (in particular metal-containing and/or non-metallic and/or metal- and polymer-poor) material components that are (not per se or not completely) melted can be bonded to the binder or polymer material and/or to each other.

The solidification of a build-up material by melting a polymeric material or a binder can be particularly advantageous because chemical and/or physical properties (e.g. electrical conductivity, electron and/or ion transport capacity, crystal and/or lattice structure) of other build-up materials, in particular of a build-up material containing metal and/or of a metal- and polymer-poor build-up material, remain unchanged. A change (deterioration) of their chemical and/or physical properties could be caused by the (partial) melting (phase change) of, in particular metal-containing and/or poor in metal- and polymer-poor, build-up materials.

In embodiments, a layer application of at least one metal-containing build-up material and at least one polymer-containing build-up material and at least one metal- and polymer-poor build-up material is carried out at least partially by means of the same coating unit.

Alternatively or in addition, a solidification of at least one metal-containing build-up material, and at least one polymer-containing build-up material, and at least one metal- and polymer-free build-up material is carried out at least partially by means of the same irradiation unit, preferably a laser unit, and/or with radiation of the same wavelength.

It is particularly preferred that the coating unit and the irradiation unit, respectively, are configured such that at least two of a metal-containing build-up material, a polymer-containing build-up material and a metal- and polymer-poor build-up material can be processed by means of the same respective unit. If necessary, additional measures can be taken to achieve this, such as the use of an auxiliary irradiation unit, heating (warming) or cooling of the build-up material and/or the use of a binder. This is a departure from the usual approach of using distinctly different additive manufacturing configurations for different materials (e.g. metal and polymer).

Preferably, a coating direction corresponds to (or is opposite to) an irradiation direction. In particular, a coating direction is understood to be a direction that corresponds to the direction of movement of a coating unit relative to the build-up material (which does not mean that the coating unit must move in absolute terms, for example if the build-up material itself moves). In particular, an irradiation direction is understood to be a direction of movement of a radiation impingement area with respect to the build-up material (again, relatively speaking). The term irradiation direction can refer to an averaged direction in which an area of a component cross-section to be hardened is scanned with the beam. It does not necessarily refer to the direction of a single solidification path or scan vector, which may possibly be arranged transversely, e.g. perpendicular, to the coating direction, in particular if the irradiation unit is coupled to a corresponding scanner/beam deflection unit or another drive. If exposure direction (irradiation direction) and coating direction are the same, a particularly precise (selective) solidification can be achieved.

An adhesion of additively manufactured layers, that are made of different materials, is preferably achieved, possibly supported by a process-related interlocking of the surfaces.

The component (of the electrochemical device) is preferably made of at least one metal-containing build-up material and/or at least one polymer-containing build-up material and/or at least one metal- and polymer-poor build-up material, wherein different layer thicknesses can preferably be set for at least one layer built up from a polymer-containing build-up material and/or for at least one layer built up from a metal-containing build-up material and/or for at least one layer built up from a metal- and polymer-poor build-up material.

By the solidification a porosity can deliberately be introduced into the component manner. A porosity can be adjusted in a targeted manner (at least locally). The porosity can have a gradient. Specifically, a number (or density, i.e. number of pores per volume) and/or size (e.g. total volume or mean pore size) can be set, in particular, varied (locally).

Alternatively, however, no porosity (apart from a usual slight porosity in the context of an additive manufacturing method) can be (deliberately) introduced, for example in the case of electrochemical devices in which lithium ions are conducted in a solid electrolyte.

A gradient of the porosity introduced in targeted manner preferably runs in the z-direction (i.e. along a surface normal to the plane of the surface of the support device or the support material; build-up direction).

A porosity can be introduced (in a desired distribution) for example by a variation of process parameter values, e.g. a scanning speed, a beam power or laser power, a scan vector distance and/or beam shaping. Alternatively or additionally, a porosity can be introduced by means of a laser afterwards (e.g. by means of a polygon scanner). The laser can create a plurality of small pores in the layer to increase the tortuosity and thus to achieve a better Li-ion transport.

The component is preferably made of a first build-up material and at least one second build-up material, wherein the higher-melting material (i.e. the material with the higher melting temperature) is preferably applied and irradiated before the lower-melting material. By this a risk can be reduced that, upon melting the higher-melting build-up material, an underlying layer of the lower-melting build-up material is (unintentionally) melted again.

For example, a separator comprising (preferably in a majority percentage by weight) a polymer can be printed after an electrode for a rechargeable battery (preferably in a majority percentage by weight) comprising a metal-containing and/or a metal- and polymer-poor and/or a polymer-containing build-up material. By this damage to the separator structure due to possibly higher laser intensities for the melting of metal (in particular if the separator has a porosity that should be retained with respect to its structure or distribution) can be prevented in an easy manner. In this case, the separator material is preferably layered only after the electrode (cathode or anode) has solidified. If, for example, a separator of ceramic (or one made of at least 50 wt.-% ceramic) is used, it may also be advantageous the other way round.

Preferably, a speed of advancement of the support material is controlled depending on an exposure time (irradiation time) and/or power of the irradiation unit (and/or vice versa). By this the speed of advancement of the build-up material can be adapted to an irradiation time (exposure time) or power.

Alternatively or additionally, a switching speed of laser device(s) (laser diodes) can be taken into account in the speed of advancement, or the speed of advancement of the build-up material can be adapted to the (maximum) switching speed and/or controlled as a function of this.

The above-mentioned object is further achieved in particular by a manufacturing device, preferably configured to carry out the above manufacturing method, for the additive manufacturing of at least one component of an electrochemical energy storage device, in particular a rechargeable battery, preferably a lithium-ion rechargeable battery, at least partially by layer-by-layer application and subsequent, in particular selective, solidification of a preferably pulverulent build-up material, comprising a receiving unit for receiving a support device in the form of a support belt, in particular formed by or comprising a support foil, a coating unit for applying a layer of the build-up material to the support belt, an irradiation unit for at least partially solidifying, in particular selectively solidifying, the build-up material on the support belt, as well as a conveyor unit for moving the support belt relative to at least a first, preferably stationary, radiation unit.

Alternatively or additionally, the above object is in particular solved by a manufacturing device, in particular with the features of the immediately preceding paragraph, preferably configured to carry out the above manufacturing method, for the additive manufacturing of at least one component of an electrochemical energy storage device, in particular a rechargeable battery, preferably a lithium-ion rechargeable battery, at least partially by layer-by-layer application and subsequent, in particular selective, solidification of a preferably pulverulent build-up material, comprising a support device, a coating unit for applying a layer of the build-up material to the support device, an irradiation unit for at least partially solidifying, in particular selectively solidifying, the build-up material on the support device, wherein the irradiation unit comprises a plurality of individual radiation exit sections, preferably arranged in at least one row and/or at least one column, in particular a plurality of laser diodes and/or radiation guide ends.

Preferably, the coating unit comprises:
at least one, in particular two or more, rolls, wherein preferably at least one of the optionally several rolls, is assigned a drive unit, wherein further preferably a circumferential speed and/or direction of rotation can be or is set, which is the same as or higher or lower than a relative moving speed of the substrate material with respect to the respective roll and/or wherein at least one roll extends at least essentially over the entire width of the substrate material and/or vibrates or can at least be made to vibrate, and/or
at least one dosing unit, which preferably comprises a chamber dosing device and/or one or several controllable outlets and/or which extends at least essentially over the entire width of the substrate material and/or at least partially vibrates or can at least be made to vibrate.

The (respective) roll and/or the dosing unit may comprise a fluidising device for fluidising build-up material, as described in connection with the above method.

The dosing unit may further alternatively or additionally comprise a rotary valve.

Alternatively or additionally to one or several rolls, at least one doctor blade and/or at least one blade and/or at least one brush and/or at least one grate can be provided.

The dosing unit can also have an agitator and/or a scraper to be able to convey adhering build-up material.

The irradiation unit can have a plurality of individual radiation exit sections (light exit sections), preferably arranged in at least one row and/or at least one column, in particular a plurality of laser diodes and/or radiation guide ends.

In addition to the (first) irradiation unit, there is preferably provided, preferably arranged in at least one row and/or at least one column, a plurality of individual radiation exit sections, an auxiliary irradiation unit, preferably at least one, in particular scanning, auxiliary laser unit, such as, for example, a CO, CO₂, fibre and/or Nd:YAG laser.

A scanning auxiliary laser unit can be designed as described above in connection with the method, in particular be coupled to a galvanometer scanner and/or polygon scanner and/or micro-mirror array.

Preferably, the manufacturing device has at least one common coating unit that is configured for layer-application of at least one metal-containing build-up material and/or at least one polymer-containing build-up material and/or at least one metal- and polymer-poor build-up material.

Alternatively or additionally, the manufacturing device has a common irradiation unit, preferably laser unit, which is configured for fixing at least one metal-containing build-up material and/or at least one polymer-containing build-up material and/or at least one metal- and polymer-poor build-up material.

The (common) irradiation unit can be assigned, for example, a filter device (for reducing the power of the radiation when it impinges on the build-up material) or a beam splitter with a beam trap, which can preferably be selectively brought into a beam path, for example, when a material with a comparatively low melting point is to be melted.

The manufacturing device can have at least one (further) coating unit for applying a further layer of a build-up material and/or at least one further irradiation unit for solidifying a further layer/the further layer.

For example, two coating units can be provided before and after the (respective) irradiation unit. By this, in the case of an irradiation unit that moves back and forth, irradiation can take place, or a new layer can be (selectively) solidified during each pass.

The manufacturing device preferably comprises at least one control and/or monitoring unit which is configured to control and/or monitor at least one parameter, in particular a flatness and/or a bulk density and/or a temperature or temperature distribution of build-up material applied to the support device and/or a flatness and/or a density and/or porosity and/or a temperature or temperature distribution of the component during manufacture, wherein the build-up material preferably comprises a polymer-containing build-up material component and/or at least one metal-containing build-up material component and/or at least one metal- and polymer-poor build-up material component.

The manufacturing device preferably comprises at least one (active) heating and/or cooling unit for indirect or direct temperature control, in particular heating or cooling, of a solidification zone in which the build-up material is solidified, preferably by heating or cooling the support device and/or by heating or cooling a base for the support device and/or by heating or cooling the build-up material, for example by means of radiation, wherein the heating and/or cooling unit is optionally provided at least partially by the irradiation unit for solidification and/or a heating unit provided in addition to the irradiation unit, e.g. an additional irradiation unit, for example an infrared radiation source.

Preferably, a tempering to, for example, a constant temperature (plateau temperature) or a temperature according to a predefined curve is done, in particular with the aim of achieving homogeneous temperature conditions for all components (of the same material) to be produced. With a heating and/or cooling unit it is possible, in particular when using different materials (e.g. in different layers), to compensate for corresponding differences in an easy manner, for example with regard to a melting temperature. For example, when melting a layer consisting of a metal-containing build-up material, additional heat radiation can be applied for heating (tempering), and when melting a layer consisting of a polymer-containing build-up material, such radiation can be omitted or reduced, or cooling can be applied. Alternatively, when melting a layer consisting of a polymer-containing build-up material, additional heat radiation can be used for heating (tempering) and when melting a layer consisting of a metal-containing build-up material, such a radiation can be omitted or only applied to a reduced extent, or cooling can be applied.

A gas (process gas) is preferably used in recycling mode (as a closed system).

It is preferable to monitor the oxygen content. Alternatively or in addition, laser smoke can be filtered. For this purpose, the following can preferably be provided: corresponding pipelines, a filter chamber with a storage filter and/or cleanable filters (which is preferred), a blower for circulation, as well as an oxygen, temperature, pressure and/or volume flow sensor.

The manufacturing device can have at least one suction unit, preferably a suction nozzle arrangement, comprising a plurality of suction nozzles, preferably arranged in rows and/or columns.

Alternatively or additionally, at least one suction unit can be provided that is designed to be stationary (in absolute terms, in particular with respect to a reference point that, in use, is part of the ground on which the manufacturing device is arranged). Alternatively or additionally, the suction unit can be designed to be stationary relative to the coating unit and/or irradiation unit. Accordingly, within the above method, a suction unit can be configured to be stationary (in absolute terms) or remain stationary during the manufacturing method in that sense. Alternatively or additionally, in the above manufacturing method, the suction unit can remain stationary relative to the coating unit and/or radiation unit (during the manufacturing method).

Further features of the manufacturing device can be derived from the above explanation of the method. Method steps explained there can be realised by appropriate devices that are configured to carry out the respective method step. Furthermore, the manufacturing device can comprise the (above and/or below described) support material and/or the (above and/or below described) build-up material.

The above-mentioned object is further realised, in particular, by a system comprising the above manufacturing device, as well as the support material and/or the build-up material.

The above-mentioned object is also realised by the use of the above manufacturing device and/or the above system for the additive manufacturing of at least one component of an electrochemical device, preferably an electrochemical energy storage device, in particular a rechargeable battery, preferably a lithium-ion rechargeable battery, and/or of an electrolytic cell.

Preferably at least 10 wt. %, preferably at least 30 wt. %, optionally at least 50 wt. % or at least 90 wt. % of the respective electrochemical device is additively manufactured.

Further features arise from the dependent claims.

The invention is described below with reference to examples of implementation, which are explained in more detail with reference to the figures. Hereby show:

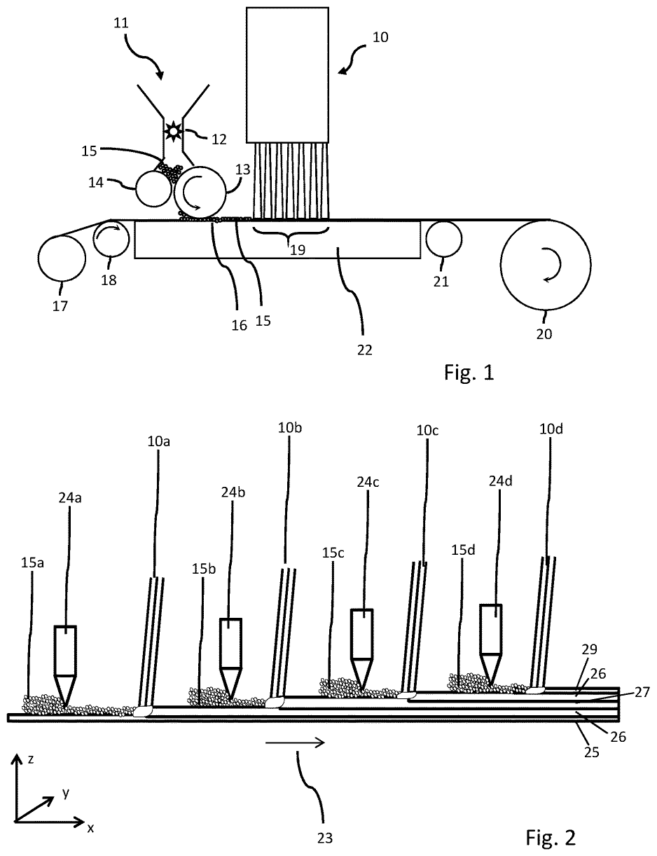

FIG. 1 a schematic view of a manufacturing device according to the invention;

FIG. 2 a schematic representation of a method for manufacturing a structured, three-dimensional layer composite;

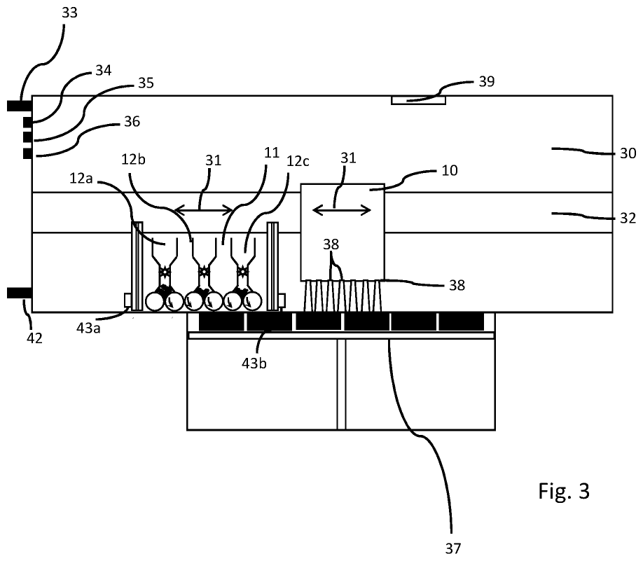

FIG. 3 a schematic representation of an additive manufacturing (for example of a solid-state rechargeable battery cell);

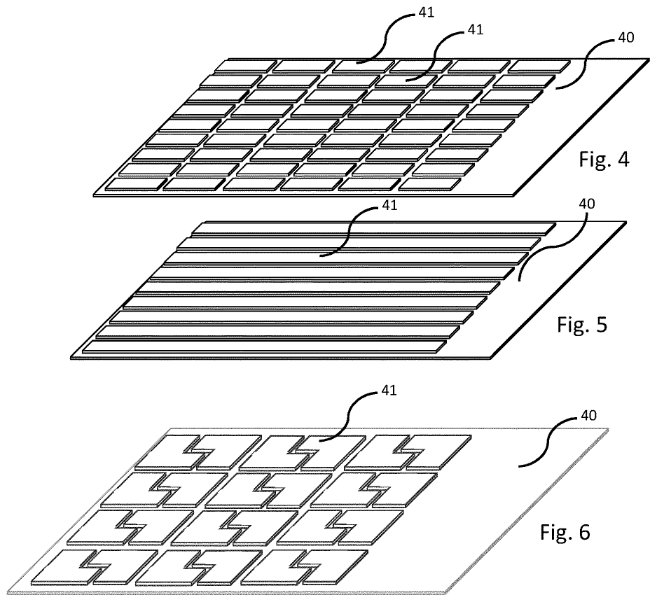

FIG. 4 an example for the manufacture of an electrochemical device;

FIG. 5 a further example for the manufacture of an electrochemical device; and

FIG. 6 a further example for the manufacture of an electrochemical device.

FIG. 1 shows a manufacturing device for manufacturing components in a schematic side view. The manufacturing device comprises an irradiation unit 10 as well as a coating unit 11. The coating unit 11 comprises a dosing device 12 as well as a coating roll (roller) 13 and a counter roll 14. Via the dosing device 12, a (e.g. pulverulent) build-up material can be dosed in the direction of the coating roll 13 and counter roll 14. The coating roll 13 is arranged and operated in such a way that it sets a thickness for the application of the build-up material 15 to a support material 16. The support material 16 is a belt (in particular a foil belt) that can be unwound from a roll (supply roll) 17. A deflection can be carried out, for example, via a (possibly driven) deflection roll 18. A deflection function is not mandatory. A thickness of the material application can be determined by adjustment of the height of the coating unit 11 or the distance between the coating roll 13 and the support material 16. Furthermore, the density of the material application can be determined by the ratio between a circumferential speed of the coating roll 13 and a moving speed of the support material (adjustable, for example, by means of a rotational speed of the roll 20, see below). Preferably, the circumferential speed of the coating roll 13 is greater than the moving speed of the support material 16. This can advantageously achieve a higher density. Alternatively or additionally, the movement of the circumference (direction of rotation) of the coating roll 13 is adjustable. In FIG. 1, the movement of the circumference of the coating roll 13 is the same as the movement (moving direction) of the support material 16. Preferably, the circumference of the coating roll 13 is moved (rotated) in the opposite direction to the movement (moving direction) of the support material 16. This can advantageously achieve a higher density. In an irradiation area 19, the build-up material 15 is then irradiated on the support material 16 and (selectively) solidified. The support material 16 with the (selectively) build-up material 15 solidified thereon can then be rolled up on a further roll 20. Between the deflection roll 18 and a further roll 21, there is a (optionally heatable) processing table 22.

The exposure unit (irradiation unit) 10 is preferably a VCSEL exposure unit. With a VCSEL exposure unit, binders and/or other materials can be melted and/or structured comparatively quickly. It is possible to print shape-bound electrodes (for battery production) in a simple manner. This enables new cell geometries, which, for example, can be adapted to the installation space and/or can have integrated cooling in the cell.

The manufacturing device shown in FIG. 1 can preferably be used for the production of an electrochemical cell comprising or consisting of:
A preferably porous cathode, consisting of a metal-containing active material resulting from the processing (by irradiation) of a metal-containing build-up material, the build-up material comprising predominantly (in particular 75-97.9 wt. %, preferably 90-96 wt. %) at least one metal-containing material (e.g. LFP, NMC, NCA and/or LCO) and conductive soot (in particular 0.1-10 wt. %, preferably 1-5 wt. %), optionally further comprising a (polymeric) binder (e.g. PVDF, in particular 2-15 wt. %, preferably 3-5 wt. %).
A separator, in particular for a (classic) battery. This can be formed as a (thin) polymer foil. The polymer may comprise (optionally at least 50 wt. % or 80 wt. %) polyolefin, e.g. polyethylene and/or polypropylene, and/or polyamide, e.g. PA 6 and/or PA 12 and/or PA 6.6, and/or polyester.
A, preferably porous, in particular with a porosity of at least 20vol.-%, optionally of at least 40 vol.-%, anode, consisting of a metal- and polymer-poor active material, which results from the processing (by means of irradiation) of a metal- and polymer-poor build-up material, wherein the metal- and polymer-poor active material predominantly comprises carbon, preferably in the form of conductive soot and/or graphite (particularly preferably in the form of graphite particles), and/or a binder (e.g. PVDF, in particular 5 -15 wt. %). Preferably, the active material contains 0.1-10 wt. %, in particular 1-5 wt. %, of conductive soot in the carbon/-portion. Further preferably the active material contains a portion (0.1-60 wt. %, particularly preferably 10-15 wt. %) of silicon in the form of at least essentially pure (elemental) silicon and/or silicon oxide, for example in the form of Si and/or SIO₂ particles, in the carbon component. Optionally, the carbon portion can be replaced at least essentially by an Si and/or an SIO₂ portion, so that the metal- and polymer-poor active material predominantly comprises silicon and/or silicon oxide, preferably at least 60 wt. %, particularly preferably at least 90 wt. % and/or a binder (e.g. PVDF, in particular 5-20 wt. %) and/or conductive soot (in particular 5-20 wt. %).

Preferably, a (classical) electrochemical Li-ion cell or components thereof can be produced according to FIG. 1. Such a cell may comprise one or several porous layers and/or a liquid electrolyte.

Such an electrochemical cell can be produced starting from a foil belt that comprises an aluminium layer (as first collector). The cathode, and successively the separator and the anode, can be built (in particular the cathode and anodes) and/or deposited (in particular the separator) on this aluminium layer (collector). Subsequently, a copper layer (as second collector) can be applied to the electrochemical cell built in this way. Alternatively, the aluminium layer and/or the copper layer (collectors) can be, for example from a metal-containing build-up material, in particular containing correspondingly at least essentially pure aluminium or copper, additively manufactured by means of the irradiation unit (10). A layer (collector) essentially consisting of pure metal (aluminium or copper) can be manufactured, in particular to achieve a certain material density and/or crystalline structure and/or porosity, by means of a heat conduction welding process, a deep welding process and/or a combination thereof.

Heat conduction welding is considered to be a process here in which the radiation power per unit area applied to the build-up material by the radiation is too low to cause vaporisation of the build-up material. The energy spreads in the build-up material via heat conduction, which results in less expansion of the radiation-generated weld pool in a direction perpendicular to the surface. In contrast, in a deep welding process, a sufficiently high radiation power per unit area is achieved so that a material transport also occurs in a direction perpendicular to the surface. This means that build-up material is evaporated and that at the same time material processed (solidified) in the previous exposure processes is (re)melted (which leads to the formation of a so-called ‘keyhole’). In particular, the build-up material can advantageously be processed in a heat conduction welding process when high surface quality (homogeneity) and/or a homogeneous crystalline structure must be achieved, whereas a processing of the build-up material in a deep welding process can be advantageous when a strong connection of the layers of the electrochemical cell (to each other and/or to a substrate) must be achieved. Such a strong connection is provided by the simultaneous melting of different layers/build-up materials.

FIG. 2 schematically shows a method for producing a structured, three-dimensional layer composite that forms an electrochemical device (e.g. a pouch rechargeable battery or a rechargeable battery in a cylinder design) in a continuous process. First of all, a support material (e.g. in the form of a belt) 16 (substrate) is brought into a process chamber (not shown). For this purpose, for example, a movable table or a (conveyor) belt can be used. Alternatively or additionally, the support material 16 itself can be built up additively (e.g. in the process chamber). An arrow 23 indicates the direction of movement (transport direction) of the support material 16 (and thus also of the further layers successively built up on it). On the left in FIG. 2, a first build-up material 15a is first applied to the support material 16 and smoothed by means of a first smoothing device (e.g. grate) 24a (whereby a layer thickness can be set at the same time).

The applied layer of the first build-up material 15a is selectively solidified by means of a first irradiation unit 10a (whereby non-solidified build-up material can for example be suctioned, in particular selectively suctioned, which is not shown in FIG. 2). A second build-up material 15b is then applied to the support material 16 as well as to the first build-up material 15a, smoothed by means of a second smoothing device 24b (or a layer thickness is set accordingly) and selectively solidified by means of a second irradiation unit 10b. These steps are successively repeated for a third build-up material 15c as well as a fourth build-up material 15d by means of a third as well as fourth smoothing device 24c and 24d as well as a third and fourth irradiation device 10c and 10d. In this process, the subsequent build-up material can be applied and selectively solidified each time above and/or next to a previously applied build-up material (if, for example, a suctioning, for example a selective suctioning, is carried out). At the end of the process, a structured, three-dimensional body can be present in which, for example, five different materials (each in itself) have been selectively solidified in particular.

The (respective) irradiation unit 10a-10d may, for example, be an irradiation unit that applies several laser beams next to one another (in the Y and/or X direction). The X direction is preferably the direction of movement of the build-up material (relative to the respective irradiation unit). The Z direction is the direction of build-up. The Y direction is a direction perpendicular to the X as well as Z direction.

Deviating from the 4-stage structure shown, fewer (e.g. two or three) or more (e.g. 5 or more) stages (with corresponding smoothing devices or coating devices and irradiation units) can also be provided. It is also possible to solidify different layers or, in separate processes, further build-up material with one respective irradiation unit (e.g. the first irradiation unit 10a), for example if a corresponding section of the support material 16 enters an irradiation area of the respective irradiation unit several times (which can be achieved, for example, by returning the support material 16 or by a circulating support material 16).

FIG. 3 shows a schematic representation of an additive manufacturing method (for example of a solid-state rechargeable battery cell). A coating unit 11 as well as an irradiation unit 10 can be displaced within a process chamber 30. A respective direction of displacement is indicated by the arrows 31. Preferably, the coating unit 11 and the irradiation unit 10 can be displaced along a corresponding guide (in particular a linear guide) 32.

The process chamber can be flooded with inert gas (e.g. argon) via an inert gas supply 42. The gas in the process chamber can leave the process chamber via a gas outlet 33. Optionally, sensors, for example a pressure sensor 34, an oxygen detection sensor 35, as well as a temperature sensor 36, can be provided to measure various parameters within the process chamber (for example, a pressure, an oxygen content and/or a temperature of the gas in the process chamber). A monitoring unit 39 is optionally provided, which can detect defects and/or abnormalities or deviations, for example a delamination.

The coating unit 11 comprises here (exemplarily) three dosing units 12a, 12b and 12c, so that different build-up materials 15a-15c can be applied. A layer composite is applied in succession (and in fact by an irradiation following the respective coating process by means of the irradiation unit 10) to a building platform 37 (which is adjustable in height). The irradiation unit 10 can have a plurality of radiation exit sections 38. A respective suction device 43a, 43b is optionally provided on the sides of the coating unit 11. These enable powder that has not been melted to be removed again.

In a preferred embodiment, two coating units are provided (not shown in FIG. 3), wherein the irradiation unit 10 can be located between the two coating units 11, so that exposure can be carried out comparatively efficiently. A respective coating chamber or a multi-chamber coater can, for example, be filled in an end position.

The manufacturing device shown in FIG. 3 can preferably be used for the production of an electrochemical cell, comprising or consisting of:
A first collector, e.g. based on aluminium (in particular for a composite cathode). This aluminium-based collector can be formed by processing (solidification by irradiation) a metal-containing, preferably pulverulent, build-up material that consists predominantly of pure aluminium.
A cathode comprising at least one or at least or exactly two metal-containing active materials, which results from the processing (by irradiation) of a metal-containing build-up material, wherein at least one first metal-containing active material may comprise and/or LATP and/or LLTO and/or LLZO and/or at least one second metal-containing active material LFP and/or NMC and/or NCA and/or LCO. Preferably, the cathode consists predominantly (75-99 wt. %, preferably 90-95 wt. %) of one or several of the above-mentioned materials. Optionally, the cathode active material can comprise at least one binder (e.g. PVDF, optionally in an amount of 1-25 wt. % or preferably 5-10 wt. %).

An electrolyte material, in particular a polymer-containing electrolyte material, for example comprising PVDF-HFP, PEO and/or Nafion, and/or in particular a metal-containing, preferably lithium-containing electrolyte material, for example LAGP, LATP, LLTO and/or LLZO. Optionally, the electrolyte material can be produced from a polymer-containing and a metal-containing build-up material, i.e. from a build-up material that comprises a polymer-containing and a metal-containing build-up material component. Preferably, the electrolyte material is formed as a solid electrolyte material. In particular, this means that the electrolyte material has a low porosity.
An anode, e.g. based on lithium. This lithium-based anode can be formed by processing (solidification by means of irradiation) a metal-containing, preferably pulverulent, build-up material consisting predominantly of pure lithium. Preferably the anode is formed as a solid cell anode; in particular, this means that the anode has a low porosity.
A second collector, e.g. based on copper. This copper-based collector can be formed by processing (solidification by means of irradiation) a metal-containing, preferably pulverulent, build-up material consisting predominantly of pure copper.

Particularly preferably, FIG. 3 can be used for a ceramic-based solid cell. Such a cell can be formed without porosity in the individual active layers. Alternatively or additionally, the anode can comprise (pure) lithium or be formed therefrom. (Pure) lithium is processed advantageously under inert gas due to its reactivity in air, which is possible in a simple manner in the device of FIG. 3. Alternatively or additionally, the cathode can be a composite of lithium-ion conductor and lithium-ion storage material (active material).

Alternatively or additionally, the build-up material can include a separator, in particular for a (classic) battery. This separator can be formed as a (thin) polymer foil. The polymer may comprise (if necessary at least 50 wt. % or 80 wt. %), for example, polyethylene and/or polypropylene, and/or polyamide, for example PA 6 and/or PA 12 and/or PA 6.6, and/or polyester. In particular, in some applications the separator can replace the solid electrolyte material. The manufacture of a component of an electrochemical cell that essentially consists of pure metal (e.g. lithium, aluminium or copper) can, in particular to achieve a certain material density and/or crystalline structure and/or porosity, be carried out by means of a heat conduction welding process, a deep welding process and/or a combination thereof. In particular, the build-up material can advantageously be processed in a heat conduction welding process if a high surface quality (homogeneity) and/or a homogeneous crystalline structure has to be achieved, whereas processing of the build-up material in a deep welding process can be advantageous if a strong connection between the layers (components) of the electrochemical cell has to be achieved. Such a strong connection is in particular given when different layers/structure materials are melted simultaneously.

FIGS. 4-6 show various examples for the production of an electrochemical device, specifically a rechargeable battery. In FIG. 4, for example, a plurality of cathode structures 41 (e.g. LFP, for example with a thickness of 45 μm) are produced on a support foil 40 (e.g. aluminium support foil, for example 12 μm thick). Solidification can be effected, for example, (locally) by means of a number of VCSEL exposure units, for example already in the form of (subsequent) pouch cells. Non-melted material can be suctioned and possibly recycled.

FIG. 5 corresponds to the embodiment according to FIG. 4 with the following differences. In FIG. 5, a continuous exposure is carried out to produce cathode strips for the production of (future) cylindrical battery cells. A corresponding irradiation (exposure) can be carried out continuously.

In a downstream step, the back side can optionally be irradiated (exposed) (in principle in an identical manner), optionally calendered and then optionally cut into ‘daughter rolls’.

FIG. 6 shows an embodiment which again corresponds to FIG. 4 with the following differences. As can be seen in FIG. 6, a different (more complicated) shape can be selected for the cathode structures 41 by means of the manufacturing method proposed here. By this an ergonomic and space-saving production is enabled. A cooling system can also be integrated, for example.

It should be noted here that all of the parts or functions described above are claimed as essential to the invention, both individually and in any combination, in particular the details shown in the drawings. Changes to this are familiar to those skilled in the art.

Furthermore, it should be noted that the broadest possible scope of protection is sought. In this respect, the disclosure contained in the claims can also be specified by features that are described with further features (even without these further features necessarily being included). It is explicitly pointed out that round brackets and the term ‘in particular’ are intended to emphasise the optional nature of features in the respective context (which does not mean, by implication, that a feature is to be regarded as mandatory in the corresponding context without such identification).

### REFERENCE SIGNS

10a-d irradiation unit (exposure unit)
11 coating unit
12a-c dosing device
13 coating roll
14 counter roll
15a-d build-up material
16 support material
17 roll
18 (deflection) roll
19 irradiation area
20 roll
21 roll
22 processing table
23 direction of movement
24a-d smoothing device
25 collector
26 cathode
27 solid electrolyte
28 anode
29 collector
30 irradiation unit
31 displacement direction
32 guide
33 gas outlet
34 pressure sensor
35 oxygen detection sensor
36 temperature sensor
37 building platform
38 radiation exit section
39 monitoring unit
40 support foil
41 cathode structure
42 inert gas supply
43a, 43b suction device

1-40. (canceled)

41. A manufacturing method for the additive manufacturing of at least one component of an electrochemical device, at least partially by layer-by-layer application and subsequent solidification of a build-up material, the method comprising:
providing a support device in the form of a support belt;
applying at least one layer of the build-up material to the support belt; and
supplying the build-up material to an irradiation area of at least one first irradiation unit and at least partially solidifying the build-up material on the support belt with the at least one first irradiation unit.

42. The manufacturing method according to claim 41, wherein the manufacturing method is a continuous process.

43. The manufacturing method according to claim 41, wherein the support belt and/or its support foil is/are provided in an at least partially rolled up and/or folded state.

44. The manufacturing method according to claim 41, wherein the support belt and/or its support foil is/are at least partially rolled up and/or folded after the solidification of the build-up material.

45. The manufacturing method according to claim 41, wherein the build-up material is transferred, after solidification, from a support material of the support belt, to a further second support material, or remains on the support material of the support belt.

46. The manufacturing method according to claim 41, wherein a back side of the support belt and/or of its support foil is also provided with a solidified layer of a build-up material.

47. The manufacturing method according to claim 41, wherein the application is effected by means of a stationary coating unit and/or wherein the solidification is effected by means of a stationary irradiation unit.

48. The manufacturing method according to claim 41, wherein the irradiation unit has a plurality of individual radiation exit sections.

49. The manufacturing method according to claim 41, wherein the support belt moves during an irradiation by the irradiation unit.

50. The manufacturing method according to claim 41, wherein a coating unit for applying the build-up material comprises:
at least one roll which is assigned a drive unit, wherein a circumferential speed of at least one roll is or can be set, which is equal to or different from a relative moving speed of the support belt with respect to the respective roll and/or wherein at least one roll extends at least essentially over the entire width of the support belt and/or vibrates or can be made to vibrate and/or has a fluidising device, and/or
at least one dosing unit for dosing the build-up material onto the support device, which comprises a chamber dosing device and/or one or several controllable outlets and/or which extends at least essentially over the entire width of the support belt and/or at least partially vibrates or at least partially can be made to vibrate and/or has a fluidising device.

51. The manufacturing method according to claim 41, wherein the solidification takes place in a process chamber and/or under a process gas atmosphere which is essentially free of oxygen, comprising nitrogen and/or at least one noble gas, wherein the support belt extends completely or only partially within the process chamber or process gas atmosphere.

52. The manufacturing method according to claim 41, wherein a solidification zone in which the build-up material is solidified is heated or cooled directly or indirectly, by heating or cooling the support device and/or by heating or cooling of a base for the support device and/or by heating or cooling the build-up material, by means of the irradiation unit for solidification and/or a further irradiation unit.

53. The manufacturing method according to claim 41, wherein the build-up material is selectively removed, after an initial application and selective solidification of the build-up material and before a selective application of a further build-up material, by means a suction nozzle arrangement that comprises a plurality of suction nozzles, and/or wherein the suction nozzle arrangement is arranged on the coating unit.

54. The manufacturing method according to claim 41, wherein the build-up material comprises particles, wherein the particles of the build-up material have a mean particle size of at least 1 μm and/or at most 5 μm, wherein the build-up material comprises a powder and/or a particle suspension, and/or
wherein the build-up material is formed from a synthetic resin in its initial state, and/or
wherein the build-up material comprises at least one coherent body.

55. The manufacturing method according to claim 41, wherein the build-up material comprises:
a cathode active material, a binder, and conductive soot, and/or
an anode active material, binder, and conductive soot, and/or
a solid cell anode active material, and/or
a solid electrolyte material.

56. The manufacturing method according to claim 41, wherein a coating direction corresponds to an irradiation direction.

57. The manufacturing method according to claim 41, wherein a porosity is introduced into the component in a targeted manner by the solidification and/or at least adjusted locally in a targeted manner, wherein the porosity has a gradient.

58. A manufacturing device configured for carrying out the manufacturing method according claim 41, for the additive manufacturing of at least one component of an electrochemical device, at least partially by the layer-by-layer application and subsequent solidification of a build-up material, comprising a receiving unit for receiving a support device in the form of a support belt, a coating unit for applying a layer of the build-up material to the support belt, an irradiation unit for at least partially solidifying the build-up material on the support belt, as well as a conveyor unit for moving the support belt relative to at least a first irradiation unit.

59. The manufacturing device according to claim 58, wherein the coating unit comprises:
at least one roll assigned a drive unit, whereby a circumferential speed and/or direction of rotation of at least one roll is or can be set to be the same as or higher than or lower than a relative moving speed of the support belt with respect to the respective roll and/or whereby at least one roll extends at least essentially across the entire width of the support belt and/or vibrates or at least can be made to vibrate, and/or
at least one dosing unit, which comprises a chamber dosing device and/or one or several controllable outlets and/or one or several controllable rows and/or columns of outlets and/or extends at least essentially over the entire width of the support belt and/or at least partially vibrates or at least partially can be made to vibrate.

60. The manufacturing device according to claim 59, wherein a common coating unit is provided, which is configured for the layer application of at least one metal-containing build-up material, and/or at least one polymer-containing build-up material, and/or a metal- and polymer-poor build-up material, and/or wherein a common irradiation unit is provided, which is configured for solidifying at least one build-up material which comprises at least 50 wt. % metal, and at least one build-up material which comprises at least 50 wt. % polymer.
